(19) United States
(12) Patent Application Publication
(10) Pub. No.: US 2012/0233546 A1
(43) Pub. Date: Sep. 13, 2012

(54) SYSTEM AND METHOD FOR PROVIDING VOICE, CHAT, AND SHORT MESSAGE SERVICE APPLICATIONS USABLE IN SOCIAL MEDIA TO SERVICE PERSONAL ORDERS AND REQUESTS BY AT LEAST ONE AGENT

(75) Inventors: Nitin Gupta, Kingsway Camp (IN); Raj Sharma, McLean, VA (US); Ramana Reddy, Ashburn, VA (US)

(73) Assignee: 3CLogic, Rockville, MD (US)

(21) Appl. No.: 13/103,947

(22) Filed: May 9, 2011

Related U.S. Application Data
(60) Provisional application No. 61/450,543, filed on Mar. 8, 2011.

(51) Int. Cl. G06F 3/01

(52) U.S. Cl. 715/705

(57) ABSTRACT

An application that provides voice, chat, or short message services on a social media site to present a data field in a user interface for a person to enter information to request support, make a purchase, or seek information; presents an option to a person that allows the person to select how they want to be contacted by at least one agent; captures information from the social media site for the person; populates a preformatted note with the personal information and selection received from the person, the preformatted note having fields corresponding to the information and contact option, with the preformatted note formed by populating an input field with corresponding information or a selection by the person; stores all or part of the preformatted note as the record of the person's request for support; implements an algorithm to determine social affinity to route the request to at least one agent or another phone number or an automated response machine; and routes the request by voice or data channel, tracks the request and response, reports the results, and uses those results as feedback for future routing for the person or the person's social contacts.

### CROSS REFERENCE TO RELATED APPLICATIONS

This application is a U.S. Non-provisional of U.S. Provisional Application No. 61/450,543, all of the contents of which are incorporated herein by reference in their entirety.

### BACKGROUND OF THE INVENTION

The disclosure generally relates to social media e-commerce, specifically voice and text applications.

Currently voice and text based applications do not take full advantage of integration within social media, especially in the area of servicing personal orders and requests. The use of social media has increased dramatically in the past several years, particularly among businesses and other organizations. It is only logical for them to want to maximize their market potential through this growing trend.

The present disclosure provides for interactive voice and text applications for laptops, tablets, and cellular phones. In particular, the invention is an application that consumes social data about the person and interfaces the person with the most socially affable agent on the social site through voice, chat or short-messaging channels. A person enters information and selects a contact option. The request is routed to a socially affable agent and responses are recorded to improve the social affinity of the person towards the agent.

Through voice and text applications brand ambassadors can now interact with prospects to promote and/or sell their products and services, and provide support directly from their social media site.

Further, the addition of voice and text capabilities to sites empowers agents to leverage the power of social media. A person that receives personal attention through interaction with an agent, whether it be by voice, chat, or short message service, is more likely to become a repeat customer. They in turn will be more likely to refer their friends and acquaintances, increasing the customer base of the merchant.

A person is more likely to become a customer or refer a friend if they communicate with an agent who they are comfortable communicating with because of a previous conversation or a recommendation by and/or link to their social circle.

### BRIEF SUMMARY OF THE INVENTION

In accordance with the disclosure, the system is an application that provides voice, chat, or short message services on a social media site to present a data field in a user interface for a person to enter information to request support, make a purchase, or seek information; presents an option to a person that allows the person to select how they want to be contacted by at least one agent; captures information from the social media site for the person; populates a preformatted note with the personal information and selection received from the person, the preformatted note having fields corresponding to the information and contact option, with the preformatted note formed by populating an input field with corresponding information or a selection by the person; stores all or part of the preformatted note as the record of the person's request for support; implements an algorithm to determine social affinity to route the request to at least one agent or another phone number or an automated response machine; and routes the request by voice or data channel, tracks the request and response, reports the results, and uses those results as feedback for future routing for the person or the person's social contacts.

In another aspect of the disclosure, a method encompasses rendering an application that provides voice, chat, or short message services on a social media site, the application being embeddable, copyable, and allowing at least one user action; receiving at least one input related to the at least one action; updating the server based on at least one goal corresponding to the at least one action; implementing an algorithm to determine social affinity to route the request to at least one agent or another phone number or an automated response machine; and performing the actual routing of the request either by voice or data channel and then tracking the request and response and reporting the results.

Other objects will be apparent from the following description of the drawings and embodiments of the invention.

### BRIEF DESCRIPTION OF THE DRAWINGS

FIG. 1 is a diagram illustrating the system of how a person and at least one agent interact utilizing the invention.

FIG. 2 is a diagram illustrating the system of how a customer and merchant interact utilizing the invention.

FIG. 3 is a diagram illustrating how a preformatted note is populated.

FIG. 4 is a diagram illustrating the algorithm to determine social affinity to route a request.

FIG. 5 is a diagram illustrating how an application server functions.

### DETAILED DESCRIPTION OF THE INVENTION

Detailed descriptions of the preferred embodiments are provided herein. It is understood that the present embodiments may be embodied in various forms. As a result, specific details disclosed herein are not to be interpreted as limiting, but rather as a representative basis for teaching one skilled in the art to employ the present invention in any appropriately detailed system, structure or manner.

The terms talkEase™, chatEase™, and textEase™ generally relate to and are understood to mean applications for connecting a person to at least one agent. talkEase™ is a social media application that lets customers interact with merchants using voice. chatEase™ is a social media application that lets customers interact with merchants using chat. textEase™ is a social media application that lets customers interact with merchants using short message services.

The phrase “social media site” generally relates to and is understood to mean a website that allows users to interact, preferably on the internet. Social media sites include but are not limited to Facebook®, Twitter®, LinkedIn® , YouTube®, Myspace®, and foursquare®.

The phrase “data field” generally relates to and is understood to mean a field in a data entry form.

The phrase “user interface” generally relates to and is understood to mean a system by which a person interacts with a machine.

The term agent may include but is not limited to an employee, ambassador, affiliate, or volunteer.

The phrase “preformatted note” generally relates to and is understood to mean a capture of data through a communication channel. Preformatted notes can be a template or fill-in-the-blank table with preset headings, dual-tone multi-frequency captures, or a sequence of text message captures.

The phrase “input field” generally relates to and is understood to mean an entry box for a user to input text or tones to be used by a program.

The term algorithm generally relates to and is understood to mean a rule or step-by-step procedure for solving a problem.

The phrase “social affinity” generally relates to and is understood to mean a closeness or farness of a social relation that depends upon various parameters like degree of separation on social media, previous feedback given to an agent by a person, or a person's relationships or connections in social media. Level of comfort between two people depends on parameters such as relationship or connection on a social media network, degree of separation on the social media network, feedback of previous communications between two people and/or feedback of communications between a person with the other person's relationships or connections. Social relationship parameters other than direct contact include but are not limited to same city or same school.

The phrase “automated response machine” generally relates to and is understood to mean a device that allows a computer to interact with a human by voice or keypad inputs.

The phrase “voice channel” generally relates to and is understood to mean a channel or communication link with sufficient bandwidth to accommodate the transmission of speech.

The phrase “data channel” generally relates to and is understood to mean a channel or communication link used to carry control information or data signals.

The term feedback generally relates to and is understood to mean information obtained from a person through a user interface, voice channel, or data channel. Feedback may include but is not limited to ratings of an agent or comments on user experience.

The term server generally relates to and is understood to mean a computer that manages data or network communication services.

The phrase “application server” generally relates to and is understood to mean a computer that runs programs which users can access.

In a preferred embodiment, a system encompasses an application that provides voice, chat, or short message services on a social media site to present a data field in a user interface for a person to enter information to request support, make a purchase, or seek information; presents an option to a person that allows the person to select how they want to be contacted by at least one agent; captures information from the social media site for the person; populates a preformatted note with the personal information and selection received from the person, the preformatted note having fields corresponding to the information and contact option, with the preformatted note formed by populating an input field with corresponding information or a selection by the person; stores all or part of the preformatted note as the record of the person's request for support; implements an algorithm to determine social affinity to route the request to at least one agent or another phone number or an automated response machine; and routes the request by voice or data channel, tracks the request and response, reports the results, and uses those results as feedback for future routing for the person or the person's social contacts.

In a preferred embodiment, the application captures feedback from the communication between person and agent and sends it to a server.

In a preferred embodiment, the data field is a request form that allows a person to enter information and to select a contact option.

In a preferred embodiment, the information may include the person's name, phone number, e-mail, address, code or reference number, comments, a social relationship or social contacts of a person, or a combination thereof.

In a preferred embodiment, the contact option includes voice, chat, short message service, or a combination thereof.

In a preferred embodiment, data is gathered from the social media site and the request form.

In a preferred embodiment, the data is analyzed to determine a socially affable agent.

In a preferred embodiment, the request is routed to an application server which posts the information and sends it to a communication server.

In a preferred embodiment, social affinity is determined from parameters such as degree of separation from the person, or feedback from the person or the person's social relations.

In a preferred embodiment, the communication server connects the person to at least one agent.

In another preferred embodiment, a method encompasses rendering an application that provides voice, chat, or short message services on a social media site, the application being embeddable, copyable, and allowing at least one user action; receiving at least one input related to the at least one action; updating the server based on at least one goal corresponding to the at least one action; implementing an algorithm to determine social affinity to route the request to at least one agent or another phone number or an automated response machine; and performing the actual routing of the request either by voice or data channel and then tracking the request and response and reporting the results.

In more detail, communicating between person and agent allows for feedback to be captured and sent to a server. An application that is rendered on a social media site is selected by a person. The input is a request form that allows a person to enter information and to select a contact option. In turn, data is gathered from the social media site and the person. The request is routed to an application server which posts the information, stores data gathered in the system for future reference, and sends that information to a communication server.

In another embodiment, an agent's social information is gathered when registering the agent to a contact center or creating a list of agents that are contactable. The agent's social information is then stored.

In another embodiment, a person may navigate to a page on a social media site and be contacted by at least one agent.

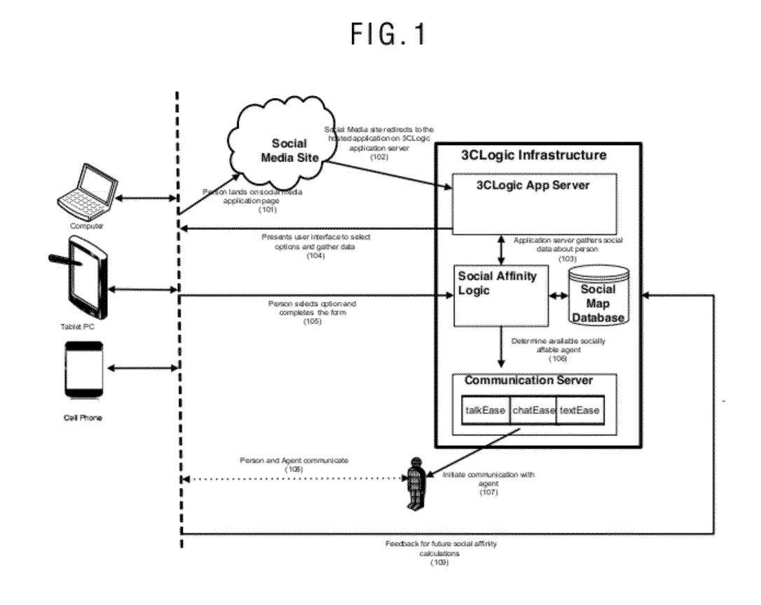

For instance, FIG. 1 illustrates the process of how a person and at least one agent interact utilizing the invention.

Referring to the invention in more detail, in FIG. 1 a person lands on a social media application page 101. The social media site redirects to the hosted application on the 3CLogic application server 102 and the application server gathers social data about the person 103. The application presents a user interface to select options and gather data 104, while the person selects an option and completes a form 105.

In more detail, still referring to the invention of FIG. 1, the most socially affable agent that is available is determined 106. Communication is initiated with the agent 107, the person and agent communicate 108, and feedback is obtained for future social affinity calculations 109.

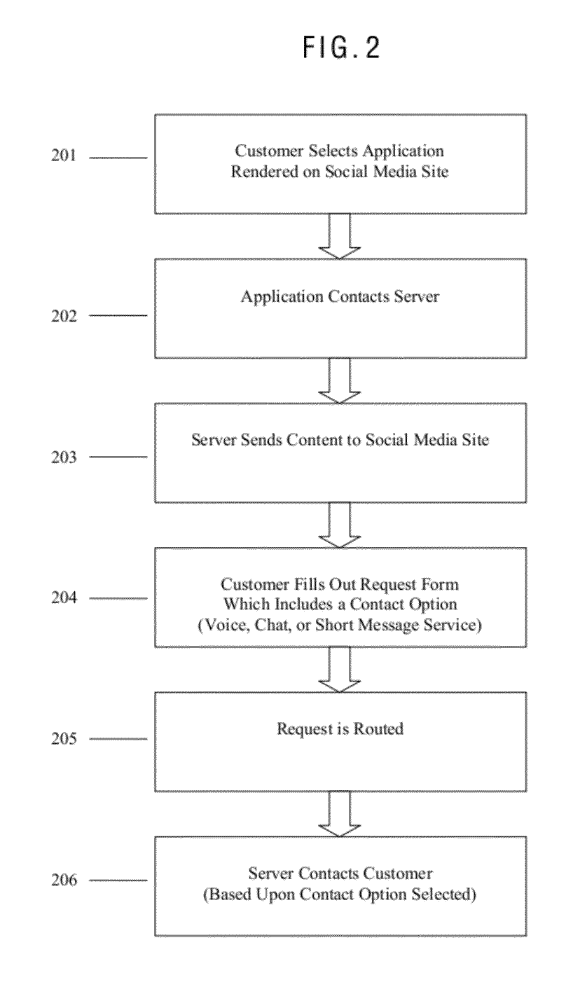

Referring now to the invention shown in FIG. 2, there is shown the process of how a customer and merchant interact utilizing the invention.

In more detail, still referring to the invention of FIG. 2, a customer selects an application that is rendered on a social media site on the internet 201. The application contacts a server 202, which sends content to the social media site 203.

In more detail, still referring to the invention of FIG. 2, the customer fills out a request form which includes a contact option 204. Options may include a voice, chat, or short message service.

In further detail, still referring to the invention of FIG. 2, the request is routed 205 and the server contacts the customer based upon the contact option selected 206.

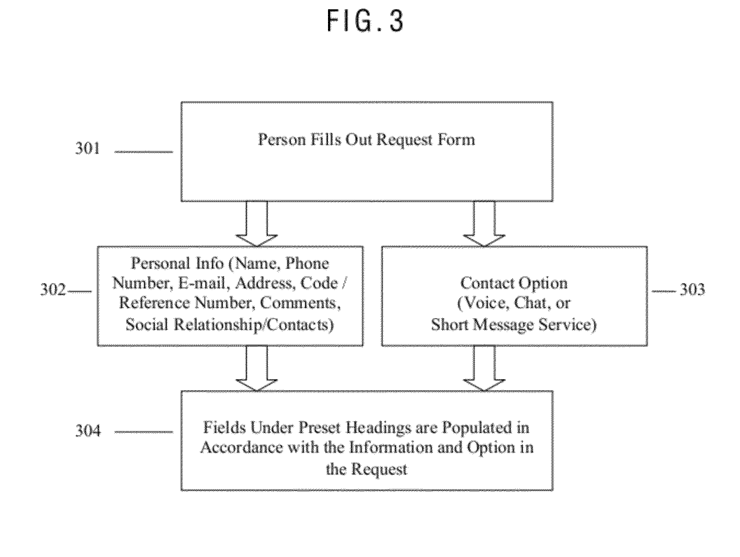

Referring now to the invention shown in FIG. 3, there is shown how a preformatted note is populated by gathering data from a social media site.

In more detail, still referring to the invention of FIG. 3, a person fills out a request form, which includes personal information and a contact option 301. Personal information may include name, phone number, e-mail, address, code or reference number, comments, and a social relationship or social contacts of a person 302. Contact options may include a voice, chat, or short message service 303.

In further detail, still referring to the invention of FIG. 3, fields under the preset headings are then populated in accordance with the personal information and contact option given in the request 304.

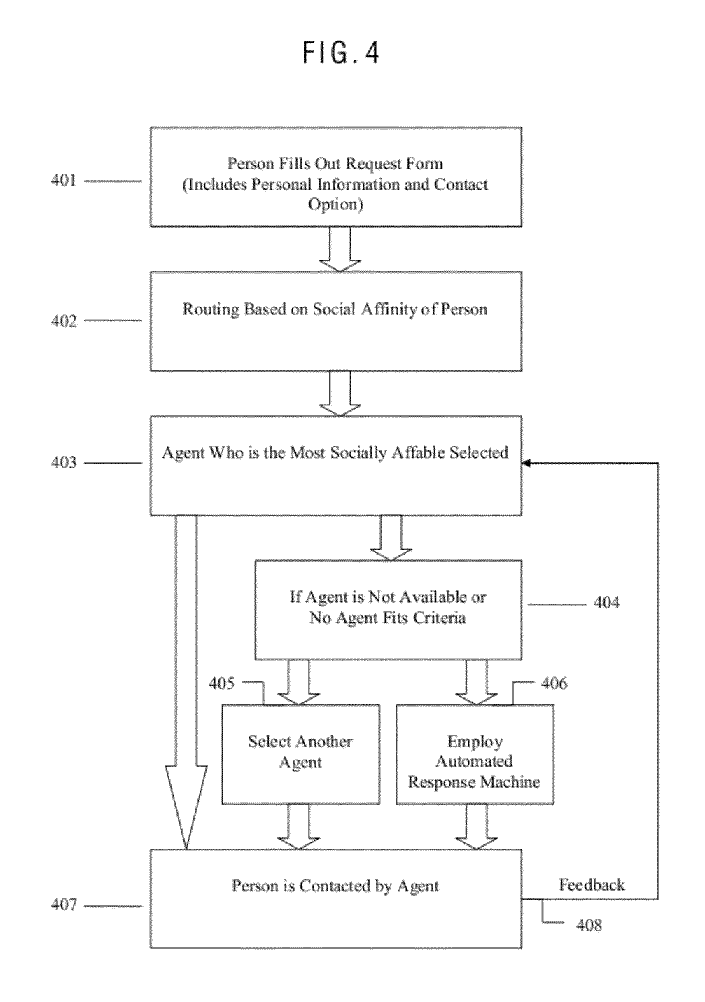

Referring now to the invention shown in FIG. 4, there is shown the algorithm for determining social affinity to route a request.

In more detail, still referring to the invention of FIG. 4, the routing is based on the social affinity of the person 402 and the contact option on the request form 401. The person is then contacted by at least one agent 407.

In more detail, still referring to the invention of FIG. 4, an agent is selected who is the most socially affable based on the contact option selected by the person 403 and prior feedback 408, if any. If the most socially affable agent is not available or there is no agent that fits the criteria 404, either an agent is selected who is less socially affable 405 or an automated response machine is employed 406.

In further detail, still referring to the invention of FIG. 4, feedback is taken directly from the person or anyone who is monitoring the communication between person and agent, which is input along with the person's social relationships to determine at least one socially affable agent who is available.

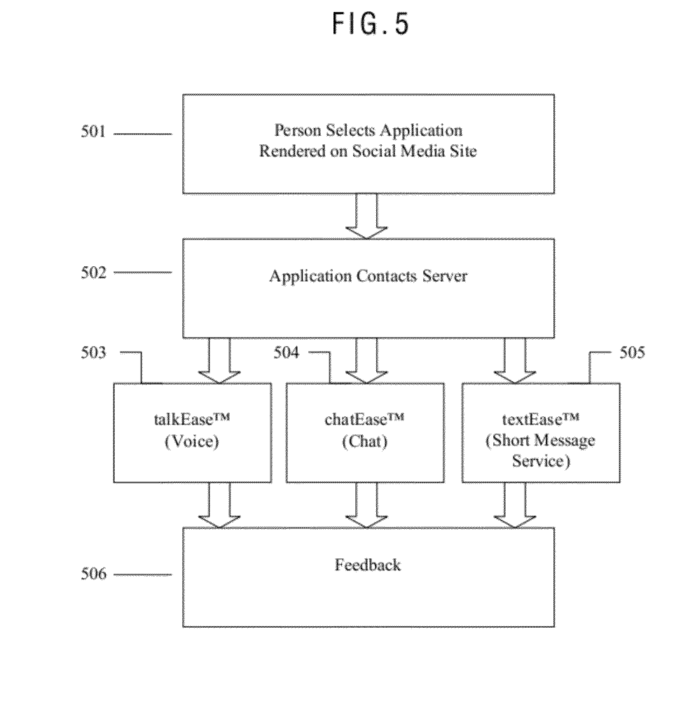

Referring now to the invention shown in FIG. 5, there is shown how an application server functions.

In more detail, still referring to the invention of FIG. 5, a person selects an application that is rendered on a social media site on the internet 501.

In further detail, still referring to the invention of FIG. 5, the application contacts a server for content 502. Content received is based upon the application selected, which may be talkEase™ 503, chatEase™ 504, or textEase™ 505, while feedback is obtained 506 no matter which application is selected.

Although the description above contains many specifications, these should not be construed as limiting the scope of the invention but as merely providing illustrations of some of the presently preferred embodiments of this invention.

Therefore, the invention should not be limited by the above described embodiments, methods, and examples, but by all embodiments and methods within the scope and spirit of the invention.

What is claimed as new and desired to be protected by Letters Patent of the United States is:

1. A system comprising:
an application that provides voice, chat, or short message services on a social media site to:
present a data field in a user interface for a person to enter information to request support, make a purchase, or seek information;
present an option to a person that allows the person to select how they want to be contacted by at least one agent;
capture information from the social media site for the person;
populate a preformatted note with the personal information and selection received from the person, the preformatted note having fields corresponding to the information and contact option, with the preformatted note formed by populating an input field with corresponding information or a selection by the person;
store all or part of the preformatted note as the record of the person's request for support;
implement an algorithm to determine social affinity to route the request to at least one agent or another phone number or an automated response machine; and
route the request by voice or data channel, track the request and response, report the results, and use those results as feedback for future routing for the person or the person's social contacts.

2. The system according to claim 1, wherein the application captures feedback from the communication between person and agent and sends it to a server.

3. The system according to claim 1, wherein the data field is a request form that allows a person to enter information and to select a contact option.

4. The system according to claim 3, wherein the information comprises the person's name, phone number, e-mail, address, code or reference number, comments, a social relationship or social contacts of a person, or a combination thereof

5. The system according to claim 3, wherein the contact option comprises voice, chat, short message service, or a combination thereof.

6. The system according to claim 1, wherein data is gathered from the social media site and the request form.

7. The system according to claim 1, wherein the data is analyzed to determine a socially affable agent.

8. The system according to claim 1, wherein the request is routed to an application server which posts the information and sends it to a communication server.

9. The system according to claim 1, wherein social affinity is determined from parameters such as degree of separation from the person, or feedback from the person or the person's social relations.

10. The system according to claim 1, wherein the communication server connects the person to at least one agent.

11. A method comprising:
rendering an application that provides voice, chat, or short message services on a social media site, the application being embeddable, copyable, and allowing at least one user action;
receiving at least one input related to the at least one action;
updating the server based on at least one goal corresponding to the at least one action;
implementing an algorithm to determine social affinity to route the request to at least one agent or another phone number or an automated response machine; and
performing the actual routing of the request either by voice or data channel and then tracking the request and response and reporting the results.

12. The method according to claim 11, wherein communicating between person and agent allows for feedback to be captured and sent to a server.

13. The method according to claim 11, wherein an application that is rendered on a social media site is selected by a person.

14. The method according to claim 11, wherein the input is a request form that allows a person to enter information and to select a contact option.

15. The method according to claim 11, wherein data is gathered from the social media site and the person.

16. The method according to claim 11, wherein the data is analyzed to determine a socially affable agent.

17. The method according to claim 11, wherein the request is routed to an application server which posts the information.

18. The method according to claim 11, wherein the application server stores data gathered in the system for future reference and sends that information to a communication server.

19. The method according to claim 11, wherein social affinity is determined from parameters such as degree of separation from the person, or feedback from the person or the person's social relations.

20. The method according to claim 11, wherein the communication server connects the person to at least one agent.
